(19) United States
(12) Patent Application Publication
(10) Pub. No.: US 2004/0032398 A1
(43) Pub. Date: Feb. 19, 2004

(54) Method for interacting with computer using a video camera image on screen and system thereof

(76) Inventors: Yedidya Ariel, Dolev (IL); Gilad Taub, Jerusalem (IL)

Correspondence Address: Barry E. Negrin, Levisohn, Lerner, Berger & Langsam, LLP, 805 Third Avenue, 19th Floor, New York, NY, 10022, US

(21) Appl. No.: 10/641,966

(22) Filed: Aug. 16, 2003

(30) Foreign Application Priority Data
Aug. 14, 2002 (IL) 151255

(51) Int. Cl. G09G 5/00

(52) U.S. Cl. 345/168; 345/156

(57) ABSTRACT

A method, device, and system for facilitating the use of and data entry into a computer having a data entry device such as a keyboard and a display device such as a monitor. A camera is disposed above the keyboard and captures a moving image of the keyboard. The image of the keyboard is shown on th display device, preferably in a small portion of the display device. In this way, a person can look at the display device and see both the subject matter he is typing or entering and the keyboard at the same time. An image of the user's hands is made transparent and overlaid onto the image of the keyboard. The image of the keyboard can be manipulated, e.g., made smaller or larger, corrected for parallax and movement, the characters on the keys can be changed, and the like.

### BACKGROUND OF THE INVENTION

1. Field of the Invention

The present invention generally relates to apparatus and methods for inputting information into a computer. Furthermore, the present invention relates to graphics processing hardware and software, useful with typing and with disparate applications—in accordance with the needs of ordinary users. More particularly, specific embodiments of the present invention relate to improved interactions with a computer for users having special or specific needs.

2. Description of the Related Art A common way for a person to interact with computers is by either typing on a keyboard or moving a mouse.

A traditional alphanumeric keyboard's first advantage is its many active keys. Each key can easily send it's meaning to the associated personal computer (or the like) when pressed by a finger. This keyboard's second advantage is the ability to allow use of all ten fingers, thus enabling rapid typing. Using finger typing on the keyboard benefits from natural human coordination and movement in hands and fingers.

However, keyboard use has drawbacks, first of which is a need to look at the keyboard while typing for the vast majority of today's users—who are not proficient in touch typing techniques! The existence of numerous methods and informative software for touch-typing is proof of its extreme inconvenience—and of the longstanding need for an improvement in this critical man-machine interface. The fact that few people actually know touch-typing demonstrates just how difficult it is to type without looking at the keyboard.

A second drawback of the keyboard is the static characters arranged thereon. Changing keyboard functions, such as caps, regular letters or foreign language letters isn't reflected in the keyboard appearance; the characters on the keyboard remain as before. A common keyboard holds two or three characters on each key. These characters are not always clear, and additional symbols cannot be displayed on existing keys.

Alternatively, using a common surface sliding hand sized “mouse” brings contradiction to the keyboard. The mouse's first advantage is the ability to operate it by allowing looking naturally at the screen only. There is generally no need to watch the mouse—except in vector graphic digitizing applications; such as cartography Moreover, it functions according to the application and transmits a function, clearly viewed on the Icon being “touched”, to the personal computer, etc.

But, the mouse, too, has its drawbacks. First it applies a mechanical unit with moving parts to navigate the screen. In addition, it typically needs a certain special pad for smooth movement. From time to time it becomes dirty, the movement is no longer smooth and navigating becomes annoying. At present, there are optical devices without moving parts to be found in the market, yet, the optical mouse has a single pointer only and the mouse still needs to be moved around in order to navigate the pointer on screen. The mouse is not free hand operated and the movement is not natural. Furthermore, the mouse's single active pointer needs to be moved from icon to icon, resulting in slow serial operating.

Virtual Keyboard software, utilizing the mouse for choosing characters, can be found in the current market. Their disadvantage is the need for serial mouse operation, i.e. the necessity to point to one character at a time, resulting in slow performance—thereby defeating the advantages of ten parallel activation digits; the fingers.

Simply stated, there is a longstanding ongoing need of improved method for inputting information into the computer. Furthermore, there is a need for improved hardware for the preferred accomplishment of meting this need and for like needs. Furthermore, there is need for improved interaction with a computer for users having specific needs and for applications with specific requirements, as well as for common user and for common application.

In particular, there is a longstanding need in the art for an improved hand-eye coordinated interface for computers and like devices wherein the manual benefit of facile substantially parallel use of multiple digits (fingers) is combined with the optical benefit of allowing eye fixation to remain primarily focused on the work per se (the screen) rather than on the interface apparatus (the keyboard). This need-based analysis is easily verified by the man-machine interface studies in many other tool related application.

### ADVANTAGES, OBJECTS AND BENEFITS OF THE INVENTION

Technical Issues: Embodiments of the invention are accomplished using a simple digital camera and substantially combinations of essentially software modules.

Ergonomic Issues: The invention is for typing the user's natural way. The sense of touch remains that of a real keyboard. Reaching each key is a free hand movement, and ten fingers do the touching naturally—as before. Vision direction and view are kept on screen. Clear graphics represent active meaning of each key. Reliability is as high as standard keyboard reliability.

Economic Issues: On the one hand, embodiments of the instant invention are accomplished with a low cost digital camera and some inexpensive software. On the other hand, embodiments of the invention provide an ongoing improvement to the efficiency of the man-machine interface—which converts into a continuous incremental improvement in user profitability.

### SUMMARY OF THE INVENTION

The aforesaid and other longstanding needs are significantly addressed by embodiments of the present invention, which specifically relates to a software-driven application keyboard imaging method. The instant method is especially useful in man-computer interactions wherein there exist a data entry keyboard-like device and a video camera, which is positioned to monitor tactile interactions with that keyboard.

In general terms, the invention includes a method, device, and system for facilitating the use of and data entry into a computer having a data entry device such as a keyboard and a display device such as a monitor. A camera or similar detection device is disposed above or near the keyboard and captures a moving image of the keyboard. The image of the keyboard is shown on th display device, preferably in a small portion of the display device. In this way, a person can look at the display device and see both the subject matter he is typing or entering and the keyboard at the same time. An image of the user's hands is made transparent and overlaid onto the image of the keyboard. The image of the keyboard can be manipulated, e.g., made smaller or larger, corrected for parallax and movement, the characters on the keys can be changed, and the like.

More specifically, the invention includes a method of facilitating human interaction with a computer having a keyboard and a display device. The method includes the steps of: a) identifying registration marks in a reference-image from an initialization video signal of a keyboard; b) relating the reference image to a predetermined graphic keyboard representation using the identified registration marks; c) processing data from post-initialization images of a keyboard in use by a user, the data including at least one of: i) at least one registration mark, and ii) differences between the reference-image and the post-initialization images; d) overlaying at least a portion of the data processed in step c) (e.g., the differences between the reference image and the post-initialization images such as the inclusion of the user's hands) onto the keyboard representation for at least a plurality of the post-initialization images; and e) transmitting the overlaid portion to a graphics display device. The method further preferably includes image processing. The aboev-mentioned relating step may include the step of selecting a representation from a predetermined library.

The processing step may include one or more of the following operations: c1) separating the non-reference image elements from reference-image elements by removing background elements; c2) deforming isolated contiguous aggregates of non-reference image elements proportionally to a predetermined distortion of the reference image; c3) deforming edges of isolated contiguous aggregates of non-reference image elements proportionally to a predetermined distortion of the reference image; and c4) tracking changes in reference-image registration mark location. These operations c1)-c4) are preferably performed substantially asynchronously. The deforming operations c2) and c3) preferably includes parameters necessary to transform a reference-image keyboard representation associated with the initialization registration marks into a substantially rectangular representation—thereby facilitating correction for angular parallax in the reference-image and in the images.

In the inventive method, the overlaying step preferably includes inclusion of registration mark normalized post-initialization video signal data edges onto the keyboard representation. The overlaying step also may preferably include the step of including registration mark-normalized post-initialization video signal data semi-transparent contiguous portions onto the keyboard representation and/or accepting a command signal and using the command to include a predetermined character set onto to keys of the keyboard representation.

The transmitting step listed above may include transforming the representation and overlay into a region of the display device—thereby facilitating a user of a keyboard of a computer system associated with the display device to observe manual interactions with the keybord on the display device. The transmitting step may include the step of transforming the representation and overlay into a region of the display device into virtual buttons on the display device corresponding to the keys of the keyboard, thereby facilitating a user of the keyboard to use the keyboard as a mouse for activating the virtual buttons on the display device corresponding to keys of the imaged keyboard.

The differences between the reference image and the post-initialization images includes at least one of movement of the keyboard and placement of the user's hands on the keyboard.

The invention also includes a software-driven application keyboard imaging method. In this method, data from a video stream is taken showing a keyboard associated with a computer and a display device; and a graphic equivalent of that data is transposed from the video stream onto a portion of the display device, so that an image of the keyboard is depicted on the display device. In transposing the data, images from the video stream may be calibrated in order to identify the viewing angle between the real time images provided from the camera and the keyboard that it is pointed at and focused on, and at least one photogrammetric or homological algorithm may be employed to accomplish the keyboard validation. The validated keyboard is transformed into an abstract animated keyboard image, and the abstract animated keyboard image is overlaid onto a portion of the display device. After a user begins to type on the keyboard, the images include edge detected abstracted animated renditions of at least one portion of one of the user's hands, the hand portion being rendered as a substantially transparent outline and superimposed onto the image of the keyboard on the display device.

The invention also includes a method of facilitating human interaction with a computer having a data entry device and a display device. An image of the data entry device as the data entry device is being used is projected onto a portion of the display device, so that the user can see both the image of the data entry device and the subject matter being created on the display device by the user's manipulation of the data entry device substantially simultaneously. Registration marks are preferably provided on the data entry device to act as reference position indicators, and the image of the data entry device is adjusted according to the registration marks. In the alternative or in addition, at least one model indicator is provided on the data entry device to identify the model (e.g., brand, specific product, etc.) of the data entry device. The model indicator is compared to a plurality of stored model indicators each indicative of a different data entry device, and an image of the data entry device indicated by the model indicator is projected onto the display device.

The image of the data entry device can be altered or improved in several ways. For example, background elements surrounding either the user's hands, the data entry device, or both can be eliminated from the data entry device image. Also, the data entry device image can be altered in accordance with user instructions, e.g., changing the characters on at least a portion of the keys on the image of the data entry device, so that typing on the actual keyboard will cause the generation of the changed characters on the display device.

An image of least a portion of at least one of the user's hands is preferably superimposed onto the data entry device image as the hands are positioned over the actual data entry device. The superimposed image are preferably made substantially transparent over the data entry device image.

The invention also includes a system for facilitating use of a computer. The inventive system may include a computer including a display device and a keyboard, or it may be provided separately and added to an existing computer. The inventive system includes a moving image camera disposed near and pointed at the keyboard, the camera generating a video signal indicative of the keyboard, and means for displaying the video signal of the keyboard onto the display device as an image of the keyboard. Registration marks may preferably be provided on a surface of the keyboard, and image repairing means for correcting distortion of the image of the keyboard in the video signal may be employed. The image repairing means may correct for parallax, movement of the keyboard from an initial position, and other deficiencies in the image of the keyboard. The means for displaying the video signal may include software disposed either on the CPU of the computer or on a CPU separate from the computer. The means for displaying the video signal may further include image altering means for changing the appearance of the image of the keyboard by altering the video signal, which, for example, changes at least some of the characters on the keys of the image of the keyboard, or eliminates background elements surrounding the keyboard and/or the user's hands above the keyboard from the image of the keyboard. The image altering means may preferably makes a user's hands disposed over the keyboard transparent in the image of the keyboard. Alternatively, the image altering means transforms keys of the image of the keyboard into hyperlinks.

The system further includes a camera holder attached to the display device, the camera being attached to the camera holder above the keyboard and pointing at the keyboard.

The inventive system may also include a second camera disposed on the keyboard pointing upward at the user's hands, the second camera generating a second video signal indicative of at least a portion of at least one of the user's hands, and means for displaying the second video signal onto the display device. In this case, the means for displaying the second video signal transforms the second video signal into a transparent image of at least a portion of at least one of the user's hands and overlays the transparent image onto the image of the keyboard.

As stated above, this software-driven application method generally includes the steps of: (A) from an initialization video signal, Identifying registration marks in a reference-image, and using the identified registration marks, Relating the reference image to a predetermined graphic keyboard representation; (B) from post-initialization video signals of images substantially similar to the reference-image, Processing data from the images, and the data is selected from the list: corresponding to at least one registration mark, and corresponding to substantial differences from respective locations in the reference-image; (C) for at least a large plurality of the images, Overlaying the processed data onto the keyboard representation; and (D) Transmitting the overlay to a graphics display device.

Now, before describing how and why these software steps accomplish the instant invention, turn attention to FIGS. 1-5 that help to visualize these steps in their true hardware environment—which in turn makes it easy to appreciate why the instant invention represents significant progress over the longstanding needs of the field.

FIG. 1 shows a schematic views of keyboard with logical or physical registration marks AND keyboard image transposed onto display device (e.g. Computer CRT) wherein there is a keyboard (100) having exterior corner registration marks; the keyboard region as defined by the registration marks is allocated on a screen (110); then a symbolic keyboard (130) is inserted into the allocated region on screen (120).

FIGS. 2-5, present this transformation in greater detail, showing schematic views wherein there is a camera (210) suspended above a keyboard (200)—in this example the camera is suspended from the screen (220) of the system having that keyboard as input device. Then there is a screen (300) having a region (310) allocated for keyboard representation which in this example shows how a keyboard might look before correction and symbolic representation using the registration marks is applied. Thereafter, after the registration marks are used and the symbolic keyboard is presented on screen (400), then one can ignore parallax and other photogrammetric factors in the relationship between the camera and the physical keyboard. Now, a user placing hands (510) on or over the keyboard results in a presentation on screen. (500) of hand representations (520) on the keyboard representation. Note that the physical hands obscure view of the physical keyboard while the representation hands do not obscure view of the representational keyboard. Finally, one can appreciate that it is straightforward to place any font on the representational keyboard regardless of what is actually inscribed on the physical keyboard. Note that in these examples the camera is held by a holder—the holder is attached to an upper portion of the screen and facilitates the pointing of the camera downwards in the direction of the keyboard. However, according to substantially equivalent embodiments of the instant invention, the camera is held by attachment to the keyboard or is held independently by a stand located on the table or thereabouts.

Simply stated, fundamental embodiments of the instant invention change the balance of hand eye coordination in typing and data entry tasks. Before the present invention, most users managed their eye fixation between the keyboard and the screen. Using the instant invention, users will be able to keep their eye fixation on screen—because real-time representations of the keyboard and of hands/fingers that are on that keyboard are symbolically portrayed on the screen. Parenthetically, when copying from a physical page, the user manages his eye fixation between the keyboard, the screen, and an external page of data or source text, as appropriate—while using the instant invention, the eye fixation is, only, between the screen and an external page of data or source text as appropriate.

Secondly, fundamental embodiments of the instant invention provide that hands, fingers, or other keyboard partial obscuring images sections are preferably represented as semi-transparent image (or simply as edges) thereabouts—and are superimposed (overlaid) onto the symbolic keyboard image.

Finally, fundamental embodiments of the instant invention provide that there is a symbolic keyboard (being a synthetic graphic representation which is proportional to the real keyboard) with superimposed edges or preferably semi-transparent representations of hands and/or fingers being transmitted to the display device driver. It should be noted that embodiments of the instant invention preferably accomplish the aforesaid using a symbolic graphic substitution for the actual keyboard instead of a complex image process version of the actual keyboard.

Now, there are various representations and interpretations that may occur at the device driver. For example, according to the preferred instant embodiment, the symbolic keyboard image occupies a lower rectangular band of the display or an upper rectangular band of the display. According to this preferred embodiment, processed fingers image, is portrayed as resting over the symbolic keyboard image.

However, according to another interesting embodiment, at least a major portion of the symbolic keyboard image is morphed (stretched) to fit over the entire display screen image (as a semi-transparent overlay). According to this interesting embodiment, the display portrayed keys of the keyboard are interpreted as activating active hyperlinks (texts or “buttons”) in the display image—thereby eliminating the need for a mouse; especially for display screen that will be designed with the instant man-machine interface in mind. Here, there is a correlating of the real keyboard keys area to the whole screen area, instead of the use of the graphic keyboard, allowing the user to control and operate icons, check boxes, or the likes—all over the screen.

Furthermore, there are numerous other potential embodiments which conform to the need of complex scripts, such as Japanese (Katakana or Hiragana), mathematical formulas, cartographic symbols, Greek letters, and the likes. For these types of scripts, the instant invention provides for portrayal of the respective key functions on the display's symbolic keyboard image. Simply stated is it relatively easy to replace one portrayal with another—which is not the case for the physical keyboard, which comes with predetermined symbols engraved thereon and which has limited space for the addition of additional “stick on” symbols. Embodiments of the invention have significant advantage for multi-characters languages such as the Southeast Asian languages, especially enabling keyboard present different sets of letters as required.

In addition, it should be appreciated that other embodiments of the instant invention facilitate man-machine interactions for persons with special perceptual needs, such as typing sticks (used by paraplegics), morph-based graphics for proactively altering dyslexic “habits”, color code reinforcing symbolic graphics for proactively altering other perceptual or cognitive difficulties that some individuals have when attempting typing (or mouse actuation) activities, etc. The clear graphic representation of the keyboard eases performing activities needed for ‘writing’. These activities include: Eye focusing, Eye—attention keeping, Characters reading, Characters writing, Attention keeping for tracking the sentence build up from words which build up from letters, and the likes.

It is especially important to appreciate that the clear graphic representation of the keyboard on the screen will help individuals having attention, perceptual or cognitive difficulties such as Hyperactivity, Dyslexia, and Dysgraphia. Specifically, reducing the number of eye fixation locations and allowing visual representations of hands/finger to be quasi-transparent (so as not to obscure the symbol corresponding to the keyboard key) will be helpful in making typing more accessible to such persons.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings, in which:

FIG. 1 shows schematic views of both physical and representation-on-screen keyboards respectively with logical or physical registration marks;

FIGS. 2-5 show schematic presentations of the physical to representational transformation in the context of necessary apparatus and appurtenances;

FIG. 6 presents a schematic view of the software-driven application method of the instant invention;

FIG. 7 illustrates a schematic view of a holder for holding a camera as needed in the instant invention;

FIG. 8 illustrates a schematic view of a symbolic video stream transformation;

FIGS. 9-12 illustrate detailed schematic block diagrams of the steps of operation of the instant invention; and

FIG. 13 illustrates schematic views of actualized logical font substitutions.

FIG. 14 illustrates a schematic view of a more detailed background processing system.

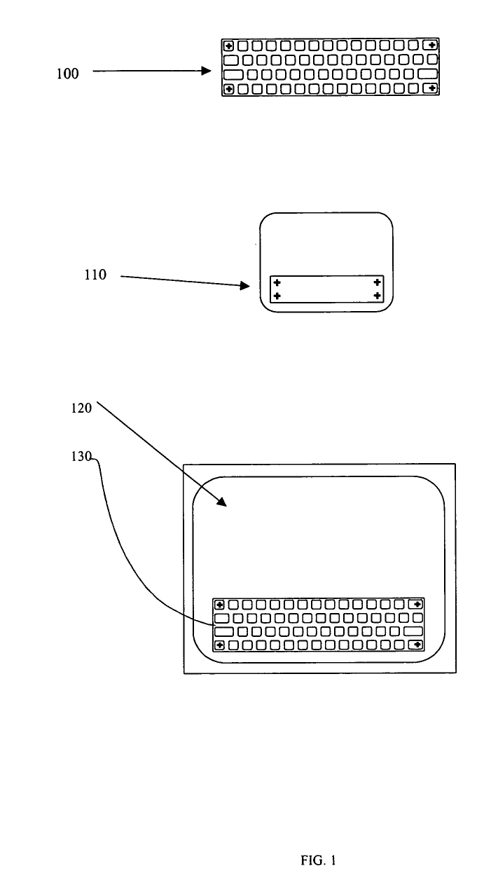

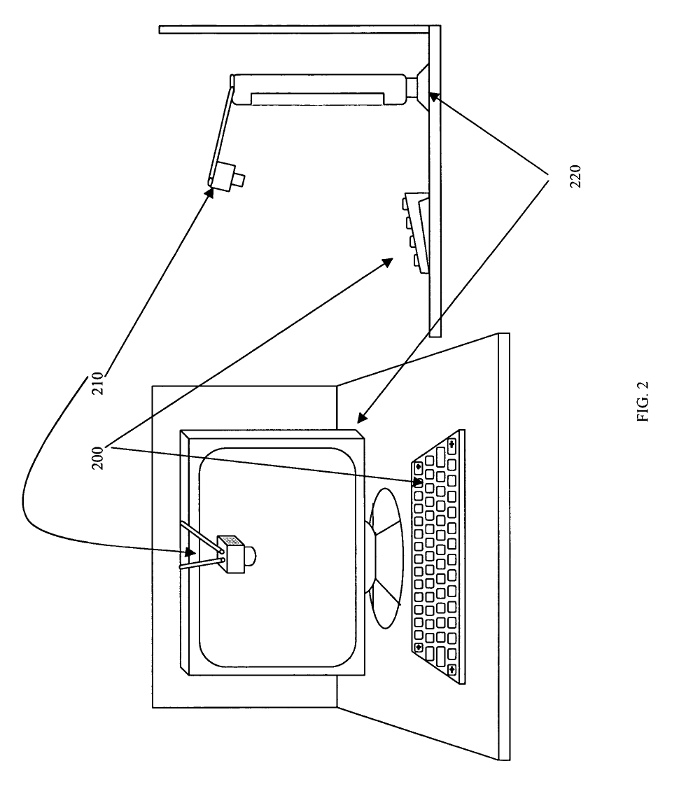

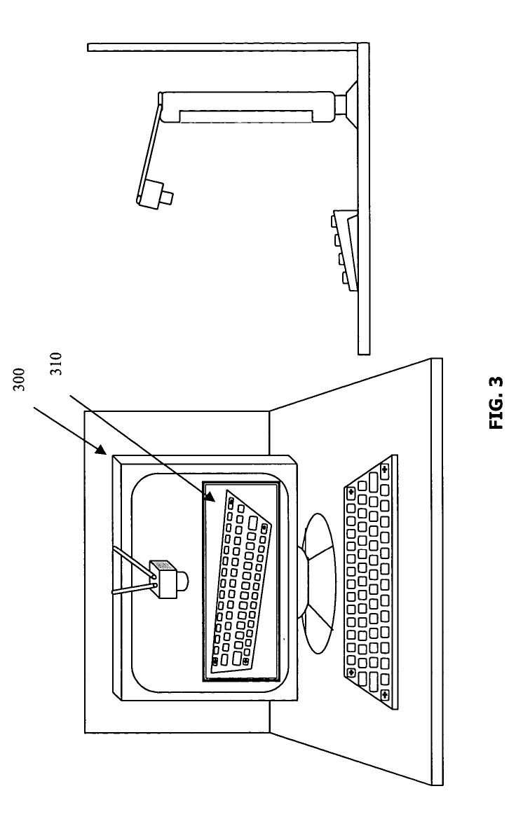

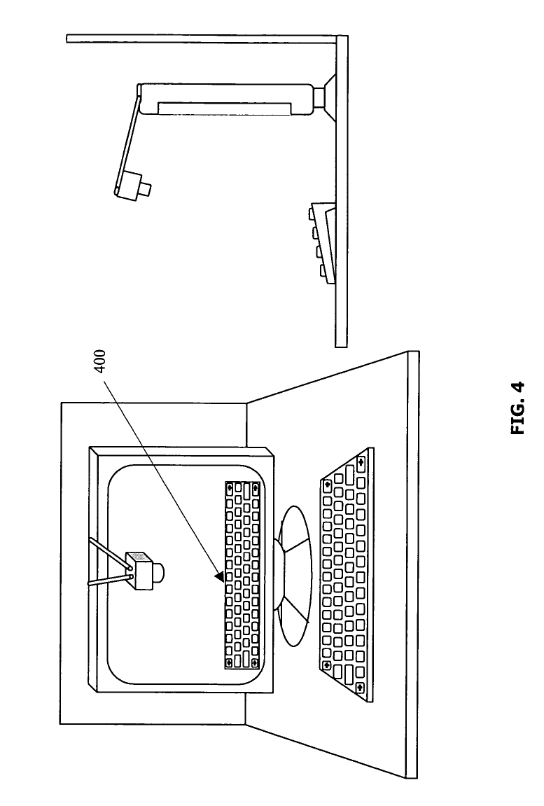

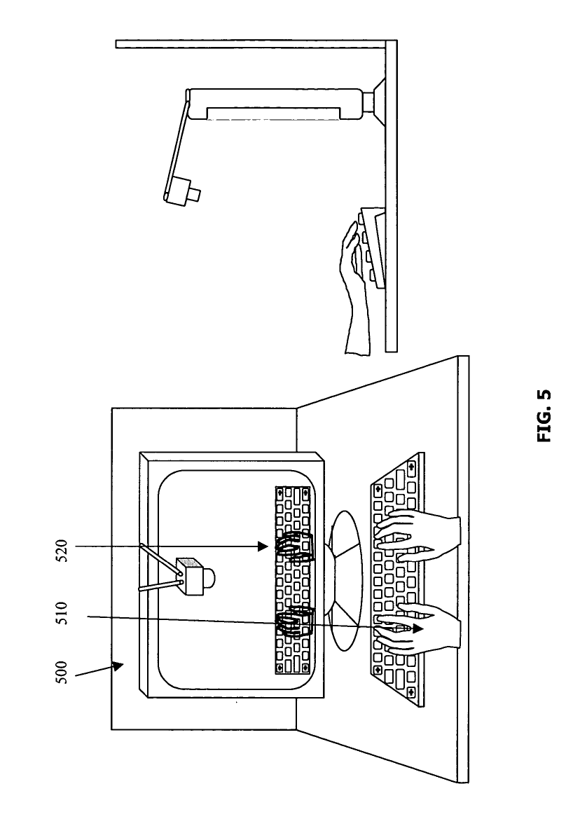

### DETAILED DESCRIPTION OF THE INVENTION

The present invention relates to embodiments of a software-driven application keyboard imaging method. The instant method is especially useful in man-computer interactions wherein there exist a data entry keyboard-like device and a video camera, which is positioned to monitor tactile interactions with that keyboard.

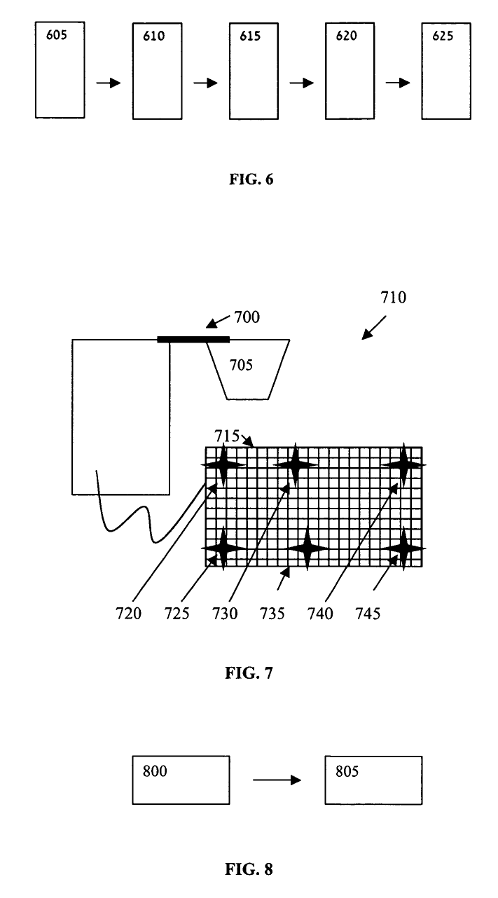

This software-driven application method generally (see FIG. 6) includes the steps of: (A) from an initialization video signal, Identifying (605) registration marks in a reference-image, and using the identified registration marks, Relating (610) the reference image to a predetermined graphic keyboard representation; (B) from post-initialization video signals of images substantially similar to the reference-image, Processing (615) data from the images, and the data is selected from the list: corresponding to at least one registration mark, and corresponding to substantial differences from respective locations in the reference-image; (C) for at least a large plurality of the images, Overlaying (620) the processed data onto the keyboard representation; and (D) Transmitting (625) the overlay to a graphics display device. Briefly, the specific nature of these steps is as follows:

The step “(A) from an initialization video signal, Identifying registration marks in a reference-image, and using the identified registration marks, Relating the reference image to a predetermined graphic keyboard representation” can be decomposed to a specification wherein there is or was a video signal from the video camera that monitored (at least one frame having) the keyboard in a hands-off mode such that predetermined registration marks (being arbitrary optically identifiable symbols such as are commonly used in the printing industry—or being a predetermined set of alphanumeric symbols that are typically imprinted on keyboard keys or thereabouts) can be identified and therewith a relationship can be established between positions in the video stream from the camera (now and substantially in the future of this arrangement) and a preponderance of graphic image portions in a stylized representation of the physical keyboard. Simply stated, there is a simple software database coordination operation that allows correspondence to be made between the video image of the physical keyboard and a stylized graphic representation of same which will be presented on a display device. Thus it should be understood that neither the video stream nor an image processed version of the video stream is being prepared for on screen presentation—since the image is hereinafter substituted by a stylized equivalent.

The stylized graphic representation of the keyboard will be proportional to the real keyboard. The stylized graphic representation of the keyboard was prepared based on the real keyboard in one of the following or alike: By processing the real keyboard image into synthetic stylized graphic representation or By recognizing the keyboard type (Manufacturer and Model) and retrieving its physical layout from a predetermined data base or By starting from graphic presentation of general keyboard and enabling image processing software or the user itself to modify the general graphic keyboard layout so it will fit the proportions of the real keyboard or Any combination of the above or other methods.

Furthermore, the step “(B) from post-initialization video signals of images substantially similar to the reference-image, Processing data from the images, and the data is selected from the list: corresponding to at least one registration mark, and corresponding to substantial differences from respective locations in the reference-image” can be decomposed to a specification wherein further video signals capturing an image of the keyboard may be processed to allow stylistic representation of hands (or other implements) which obstruct the camera's view of the keyboard—nevertheless some registration marks or the likes are characteristically necessary to allow correct spatial correspondence between visual obstructions and the underlying alphanumeric facilitating keys of the keyboard.

Now, the step “(C) for at least a large plurality of the images, Overlaying the processed data onto the keyboard representation” can be decomposed to a specification wherein proper juxtaposition of a stylized characterization of the obstruction (e.g. hands, fingers, etc.) and a stylized characterization of the keyboard are accomplished in software.

The overlaying could be done in several methods: Overlaying the processed hands image on the processed keyboard graphics or Dividing the keyboard graphic representation into two layers as follows: bottom layer holds the graphic layout of the keyboard and of the keys while the upper layer holds the characters or script or symbols attached to each key, the processed hands image could be implemented as intermediate layer on top of the graphic layout and below of the characters so the processed hands image will be viewed with its orientation to the keyboard structure yet it won't obscure the keyboard related characters.

Finally, the step “(D) Transmitting the overlay to a graphics display device” can be decomposed to a specification wherein a video convolution capturing the real time juxtaposition is directed to the graphics driver of the display device for display thereon—according to predetermined screen location allocation parameters.

According to a variant embodiment of the instant invention, identifying includes image processing—such as edge detection, centroid and/or axis identification, morphing, de-blurring, and the likes. Alternatively the separation of the ‘hands’ could be done by image processing which not ‘identifying’ the ‘hands’ but separate it directly by color separation background removal etc.

According to another variant embodiment of the instant invention, selecting a representation from a predetermined library—so that it is not incumbent on all specific instantiations to stylize a keyboard that has been heretofore stylized and/or catalogued.

According to a significant variant embodiment of the instant invention, processing includes at least one operation selected from the list: background removal for separating the non-reference image elements from respective reference-image elements, deforming isolated contiguous aggregates of non-reference image elements proportionally to a predetermined distortion of the reference image, deforming edges of isolated contiguous aggregates of non-reference image elements proportionally to a predetermined distortion of the reference image, tracking changes in reference-image registration mark location, and the likes. Preferably processing of more than one operation in the list is performed substantially asynchronously. Furthermore, it is preferably that deforming includes parameters necessary to transform a reference-image keyboard representation associated with the initialization registration marks into a substantially rectangular representation—thereby facilitating correction for angular parallax in the reference-image and in the images.

According to a different variant embodiment of the instant invention, overlaying includes inclusion of registration mark normalized (morphed with the recognition and symbolic substitution for the camera imaged keyboard) post-initialization video signal data edges onto the keyboard representation, or of post-initialization video signal data semi-transparent contiguous portions onto the keyboard representation. The registration marks are for the internal calculation of the software, they need not be presented in the graphic keyboard representation.

Now, according to a different embodiment of the instant invention, overlaying includes accepting a command signal and using the command to include a predetermined character set (language, font, script, symbol or icon set) onto to keys of the keyboard representation.

According to another different embodiment of the instant invention, transmitting includes transforming the representation and overlay into a small region of the display device—thereby facilitating a user of a keyboard of a computer system associated with the display device to observe interactions with the keyboard on the display device.

Notwithstanding the aforesaid, there is still another embodiment of the instant invention wherein transmitting includes transforming the representation and overlay into a large region of the display device—thereby facilitating a user of a keyboard of a computer system associated with the display device to use the keyboard as a low resolution mouse for activating virtual buttons on the display device by toggling a respective key of the imaged keyboard.

The instant invention also relates to embodiments (see FIG. 7) of a holder (700) for holding a digital camera (705) in a computer system (710), and the computer system is capable of a software-driven application keyboard imaging method, and wherein the camera is held pointing at a keyboard (715) of the computer system.

In addition, the instant invention relates to embodiments of registration marks, which are purposely for use with a software-driven application keyboard imaging method, and a plurality the marks (720, 725, 730, 735, 740, 745) are located on the periphery of a keyboard.

In addition, it should be noted that the instant invention relates to embodiments of a software-driven application keyboard imaging method (see FIG. 8) taking (800) data from a video stream and transposing (805) a simulated equivalent of that stream onto a portion of a graphics display device wherein the video stream is showing a keyboard associated with a computer, which is in turn associated with the display device. Particularly, it is preferred that the transposing includes (A) calibrating images from the video screen—in order to compensate for the viewing angle and the deformation between the real time images provided from the camera and the keyboard that it is pointed at and focused on; (B) using photogrammetric algorithms to accomplish the keyboard validation; (C) transforming the validated keyboard into an abstract animated keyboard image; and (D) overlaying the abstract animated keyboard image onto a portion of the display device. Furthermore, it is specifically preferred that, after a user begins to type on the keyboard, the images include the separated and processed abstracted animated renditions of at least one hand portion and the portion is rendered as a substantially transparent outline and superimposed onto the overlay of the display device; in real time.

Simply stated, embodiments of the instant invention essentially combine known advantages of both keyboard and mouse.

The instant invention relates to embodiments of a software-driven application taking data from a video stream and transposing a simulated equivalent of that stream onto a portion of a graphics display device. More specifically, the preferred embodiment of the present invention relates to a video stream showing a keyboard associated with a computer, which is in turn associated with the display device such as computer screen.

The application generate graphic image of keyboard proportional to the real keyboard that the user uses. The graphic keyboard is displayed on the screen. The script on the graphic keyboard is clear graphic script of letters from any language or symbols or icons or any other set of characters. Each set of characters is in correlation with the functionality of the keys in the keyboard although not necessarily appear on the keys of the real keyboard. During generating the graphic keyboard, at installation or in other time, the application will learn the keys of the real keyboard and correlate them to the graphic keyboard, learning the keys is learning the key position, size, shape and code.

The camera takes video image of the real keyboard and of the hands positioned on it.

A substantially equivalent general embodiment of the instant invention real time process preferably includes mainly the following substantially sequential functions:

Capturing the image of hands on real keyboard.

Separating hands image from real keyboard image.

Tracking and compensating for keyboard image deformation.

Tracking and compensating for keyboard movements.

Deformation and movement of hands image based on the tracking and compensation done to real keyboard image to achieve rectangular keyboard.

Presenting on screen the preliminary made graphic keyboard image.

Overlay hands image on top of the graphic keyboard image.

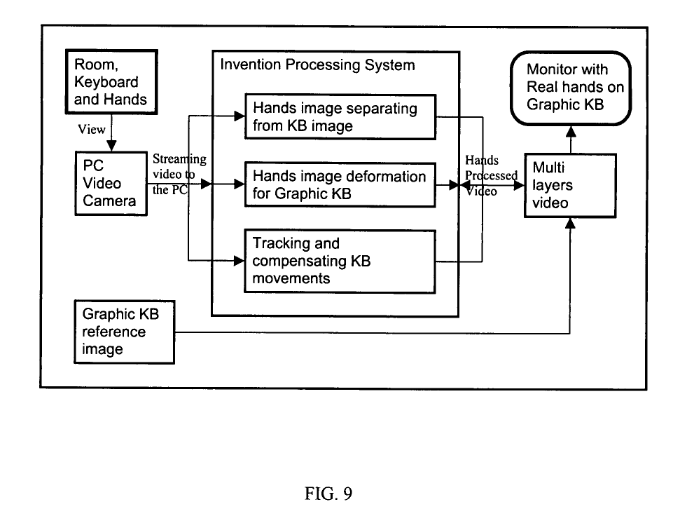

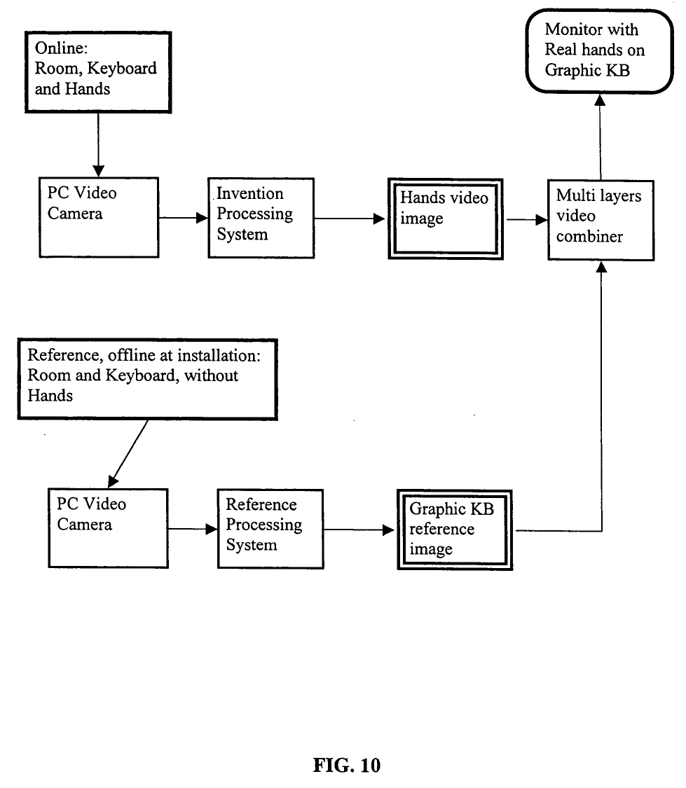

FIG. 9 is a block diagram of a typical instant application embodiment, while FIGS. 10-12 respectively present detailed portions of the block diagram—specifically to initialization and eventual use.

### Short Description of the Natural T invention

Based on Block Diagrams

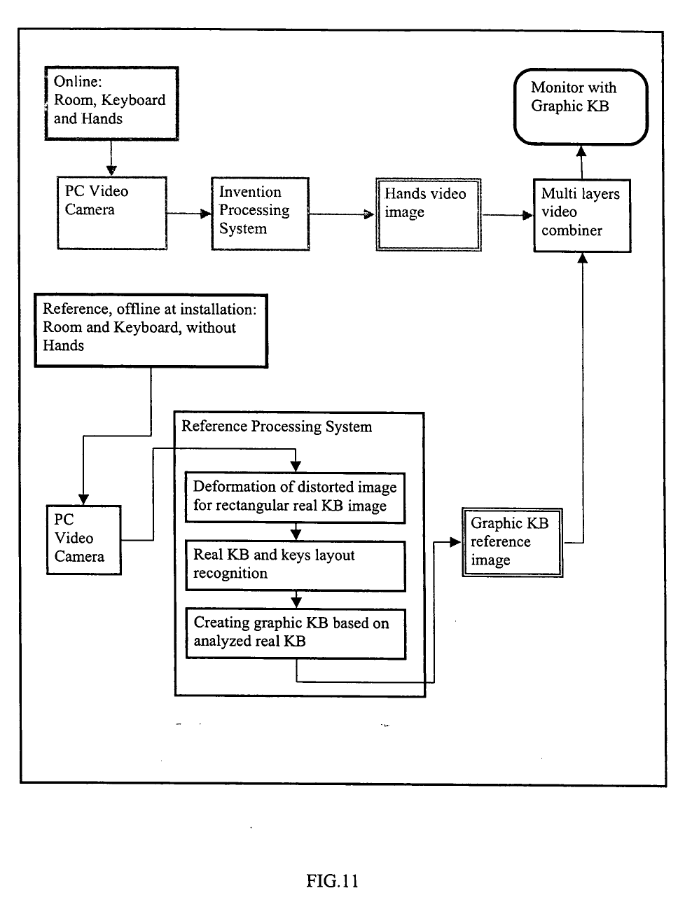

Learning the Keyboard Structure: ‘First time’ application setup, at installation or after replacing keyboard. FIG. 11.

Capturing image of the specific keyboard that attached to the user computer (real keyboard).

Processing real keyboard image for achieving rectangular real keyboard image. Will be done by using registration marks or structures from any kind.

Recognizing keyboard layout, i.e. the keys and their relative proportions (e.g. the length of the ‘Space Bar’, the shape of the ‘Enter’ etc.).

Recognizing the character(s) on each key.

Performing a synthetic graphic keyboard based on the data achieved from the real keyboard image and based on any other available data source.

Remark: c. and d. could be performed by:

Image processing for the real keyboard image, or by:

Identification of the keyboard type and structure. Such identification could be achieved from the KB DLL or from some data library etc. or by:

Graphic editing tool that will enable the user to take the ‘first guess’ of the application for the graphic structure and edit it by using tool of ‘Drug and Drop’ border-lines of the keys.

Preliminary ‘Guess’ and OCR for the characters on keys recognition, and again intuitive tool for user correction.

Output of that stage is: ‘Virtual Graphic Keyboard’ which is Proportional to the Real Keyboard, the characters on the VGK are the active character set of the user application correspondence to the real keyboard characters position.

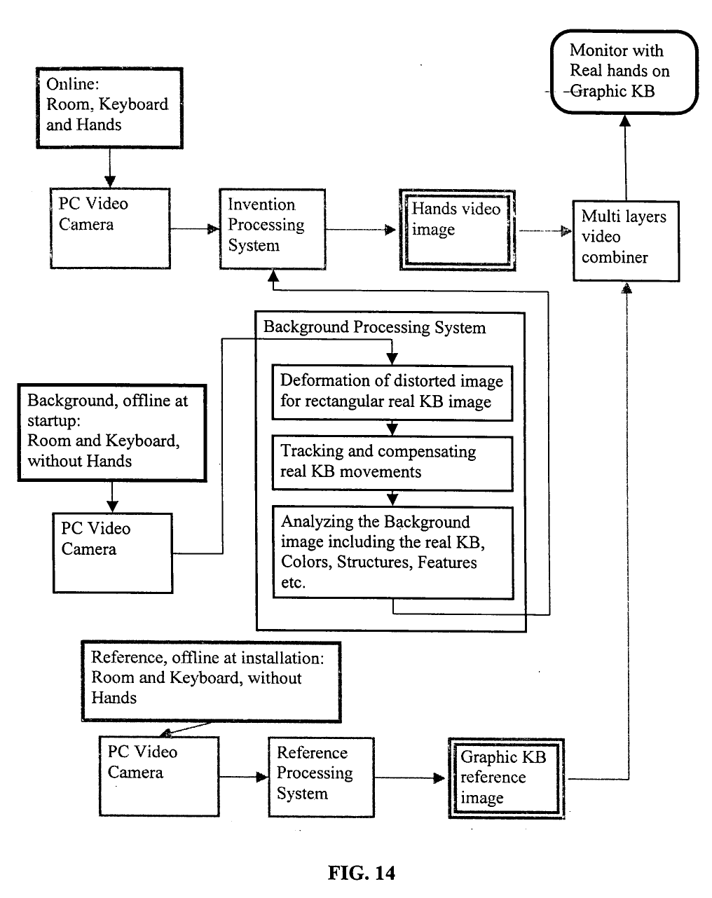

Initialization the Natural T application: Each time starting to use the application. FIG. 14.

Asking the user to take off his hands and let the application learn the background

Analyzing the image with the KB and the registration marks as above.

Verifying the fitting of the real KB to the stored synthetic VGK.

Analyzing colors, structures and features in the image as base for the background removal process in stage 3 (the real time operation).

Output of that stage is: Updated, internal parameters for use in the real time process for background removal and using the separated and deformed hands image.

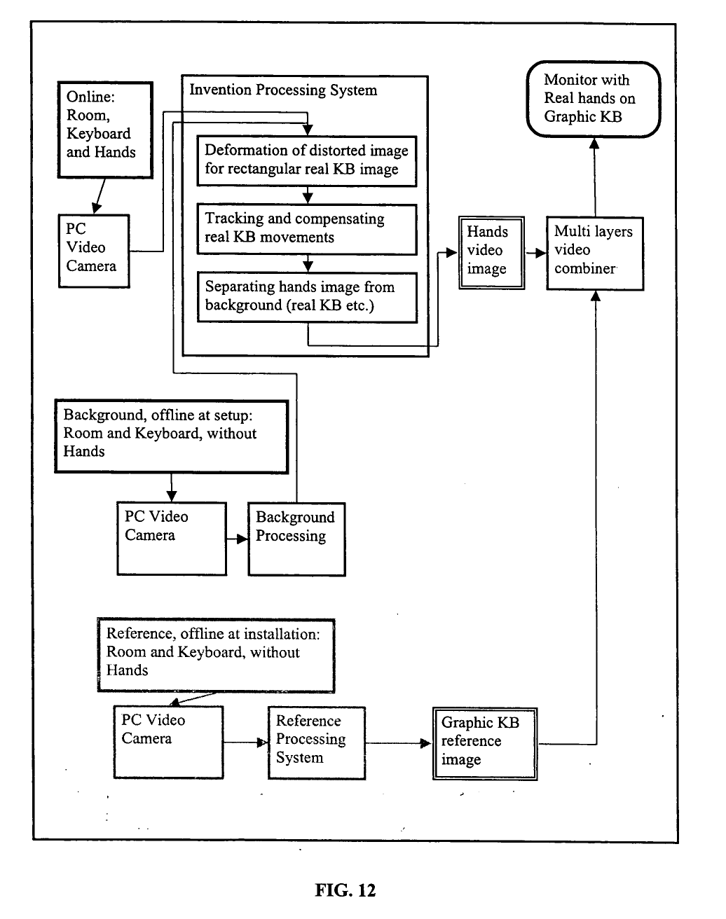

Real time operating of the Natural T application: Typing to the PC using Natural T application FIG. 12

Presenting on screen the VGK from stage 1.

Manipulating image and separating hands based on stage 2 and based on real time processing of the image.

Presenting the manipulated and separated hands image on the VGK and both on top of the user active application on screen, while presenting the ‘user application active character set’ on the ‘keys’ of the VGK.

When real key is being touched, the user application is getting the relevant character code and the correspondent ‘key’ in the VGK is ‘touched’, color change or so.

Output of that stage is: Typing to the user application while looking at screen.

For preliminary preparing the graphic keyboard, the instant application uses improved algorithms, which includes identification of the character set applicable to the keyboard—either by image processing and recognizing alphanumeric characters appearing on keys of the keyboard or using user input identity information of the keyboard (such as the keyboard model type, or such as interactively validating or correcting initial results from the recognition processing). Similar algorithms and methods are used for recognizing the keys position, size and shape. Here also the registration marks are used in order to compensate for position and deformation of keyboard image. The validated keyboard image is then transformed into an abstract animated graphic keyboard image, which is overlaid onto a portion of the display device in the form of a window with skin or the likes.

The video image of the user hands, which was separated from the entire video image and was manipulated as described above to compensate movements and deformations of the real keyboard, is presented overlaying on the graphic keyboard.

Graphic keyboard and/or hands may appear semi-transparent or transparent (principal edges only) in order to enable view of all characters on keyboard. Alternatively the hands image is overlaying on the graphic layout of the keyboard and the characters set is overlaying on top of the hands image. In order to enable view of the application below the keyboard itself may appear semi-transparent. This outlines of thereof and superimposed onto the overlay of the display device in real time.

Simply stated, this aspect relates to typewriting systems and methods for displaying partially overlying or layered sprite in conjunction with bit-mapped graphic display systems.

Second, the instant application relates to a video stream data reduction output filter, preferably for use at a standard output port of a digital camera or integrated therein or other output port, and the filter includes edge detection, and or XORing with previous frame or with the reference frames and or separating by using color separation or by any other algorithm. Once all the algorithmic processing is implemented to the camera hardware it will reduce data stream rate to minimum necessary for accomplishing the above-mentioned software-driven application, or the likes. Preferably, the output filter also includes gray-level and color code abstraction or animation (to reduce data coding). According to the version that is integral to the digital camera, the image capture and processing are accomplished in a systolic array processor having a photosensitive array (camera) front layer. Nevertheless, other architectures are also facile to accomplish the filter enhancement, including bit-slice, packet, OSI compliant, etc.

A main advantage of this invention is typewriting while looking directly, “naturally”, on screen using any standard keyboard. Image of user ‘Hands on Keyboard’ is captured by any video camera. The image of hands is recognized and separated from the rest of the picture. On screen a symbolic ‘Graphic Keyboard’ representation is displayed with proportional dimensions to the real keyboard. Streaming video image of user hands is displayed on screen on top of the graphic keyboard.

A user typewrites by looking at screen in a natural manner, while watching his hands moving on the graphic keyboard and typing on it.

Moreover the script on the graphic keys clearly present the active meaning of the key, changing script for regular or capital letters, other language letters, symbols, icons and other characters. The invention will be adapted to support applications with multi icons operation such as drawing software, Computer Aided Design software etc.

As mentioned above, embodiments of the invention has significant advantage for persons with special needs such as dyslectic, ADD, ADHD and Dysgraphics. Such persons have difficulties in focusing on the typing task due to the need to look at the keyboard and at the screen alternatively. The invention will help them to stay focus on screen and easily typewrite.

The input to a personal computer (or the likes), when key is touched, is transmitted directly from real keyboard, retaining the familiar sense and reliability of standard keyboard without need for complicated image processing for typing recognition.

Equivalently, a general specification for another embodiment of the invention is a method for permitting a user typing accurately while looking at screen only, including the following steps: Positioning a low resolution digital Camera, also known as ‘PC Camera’ above the screen or above the keyboard. Directing the camera towards the keyboard. Capturing the video image of keyboard and user hands typing on it. Separating the image of hands from the background, keyboard and the rest. Separation will be done by XOR operator or by Edge detection or by color separation or by any other technique. Presenting on the screen a graphic keyboard that has the same proportions as the real keyboard. Presenting a clear script on each keyboard corresponding to the active meaning of the key. Presenting, the hand video image on top of the graphic keyboard. The user will look at screen. While watching his hands on the graphic keyboard the user will position his hands on the real keyboard on the required key. The real keyboard will function as usual. Pressing the real key will send its code to the computer (as before). The symbolic graphic representation on the display is only used to provide visual feedback to the user—not as a virtual keyboard data interface.

It should be noted that the orientation between hand image and graphic keyboard on screen should be kept the same as the orientation between hands and real keyboard. For keeping the above orientation, special procedure is taken for tracking the movements of the keyboard and compensate for it. This procedure is based on specifying for example four registration points on the marginal keys of the keyboard or in any other location on the keyboard. The application will track the position of the registration points. The relevant transformation from the real keyboard, to the graphic keyboard will be calculated based on the registration marks. The above transformation will be implemented to the hands image for keeping the proportion between the hands image and the graphical keyboard same as the proportion between the real hands and real keyboard.

The image can be distorted from simple rectangular for example trapezoidal image can be obtained due to positioning the camera not exactly above the center of the keyboard or tilt due to camera tilting or rotating. The graphic keyboard is presented on the screen always rectangular and without movements, unless user moves it on screen. The hands video image should be transformed the same transformation needed for the distorted and tilted image of the real keyboard to be perfectly overlaying onto the graphic keyboard. Using the above transformation for compensating for the image distortion. Using the above transformation for compensating for keyboard movements. Using the above transformation for compensating for camera movements. Alternatively, when changing the active code of real keyboard, the script of the graphic keyboard will be changed accordingly. For example, switching upper case letters to lower case letters in English or changing to any other language letters.

Typical Apparatus, Setup, Implementation, and Usage:

A standard low-resolution (or better) digital camera is attached to the personal computer. Using a special holder device the camera is mounted, to a position so that it captures the real keyboard of the personal computer in a generally downward view (see FIGS. 9-12). The camera captures an image of the real (physical) keyboard. This image can be distorted due to relative position of the camera and real keyboard. The instant invention creates a graphic keyboard on screen, which is correlated to the real keyboard, by having the same proportions. This graphic keyboard is rectangular and located in specific place on screen as the user defined. The proportions of the graphic keyboard are calculated by compensating all the distortions and movements of the real keyboard.

The camera captures an image of the real (physical) keyboard with hands on it. If image rotated, mirrored or distorted, the application will correct it in order to get write oriented image on screen. The required correction manipulates the image of the real keyboard to be exactly in the same size, proportions and location on top of the preliminary made graphic keyboard. Once the correction factors to the image found an image processing procedure is done for background removing and separating the hands image from the rest of the captured image.

The script on each key of graphic keyboard is the active script or symbol of correspondent key on real keyboard. The image of hands only is displayed on screen on top of the Graphic keyboard. The relative position between image of hands and graphic keyboard is in accordance to the relative position between real hands and real keyboard.

The user uses his hands for typewriting on the real keyboard. While typewriting he looks at screen only. He then views a graphic keyboard with the image of his own hands hovering over it. When user presses real key as he sees it on the graphic keyboard on screen, the real keypad on the real keyboard sends his code to the associated computer. The user will look at the screen to see his hands on top of a graphical keyboard, both on top of the active application. The input to the associated computer will be through the real keyboard when touching it as usual, while controlling the typing through the screen.

Embodiments of the instant invention facilitate display of a context-variable keyboard image on-screen, altering the individual key labels according the current application and context. Using a live video of the keyboard, embodiments of the instant invention facilitate display of layers a real-time image of the user's hands on top of the virtual keyboard.

The initial script on the graphic key activates predetermined meaning of the real keyboard. When changing keyboard functionality, script on graphic keys is changed accordingly. Touching real key on real keyboard transmits its code directly from keyboard to associated computer, while user controls hand movement, on screen.

Embodiments of the instant invention provide a well-accepted way of typewriting, allowing the user to type in a natural manner using his own ten fingers on a simple standard keyboard while keeping looking at the screen. User sees his own hands on screen atop a virtual keyboard, revealing a clear icon of active function of each key. Structure of virtual keyboard is identical to physical keyboard, although ‘touching’ the virtual key on screen, by image of fingers presented on screen on top of the keyboard, results in actual typing on same real key on the keyboard.

The usage of embodiments of the invention enables the user to have clear graphic keyboard with the now-active characters such as small and capital letters, foreign languages, symbols, icons etc.

Embodiments of the invention include associating the physical keyboard with special functions based on specific application under use. For example, when using Mechanical CAD software, the functionality of the keyboard can be switched to related functions; keys present lines, dots, arrows etc. The new active function of each key is then presented clearly on the virtual keyboard and is operated, as before, by touching actual key while looking at virtual key on screen. Other embodiments of the invention include an ability to control mouse functions by simulating control area on virtual keyboard and using fingers imaged on screen to control it.

It should be noted that during regular use, the keyboard usually moves. In order to enable small movements of keyboard while keeping image and virtual keyboard stable on screen, a tracking procedure is applied. The keyboard is marked with registration marks, e.g. 4 marks at keyboard corners. Software tracks position of keyboard using marks for registration and compensates for keyboard movement. Tracking and compensating keeps virtual keyboard and real hands imaged on it, in a stable upright position on screen.

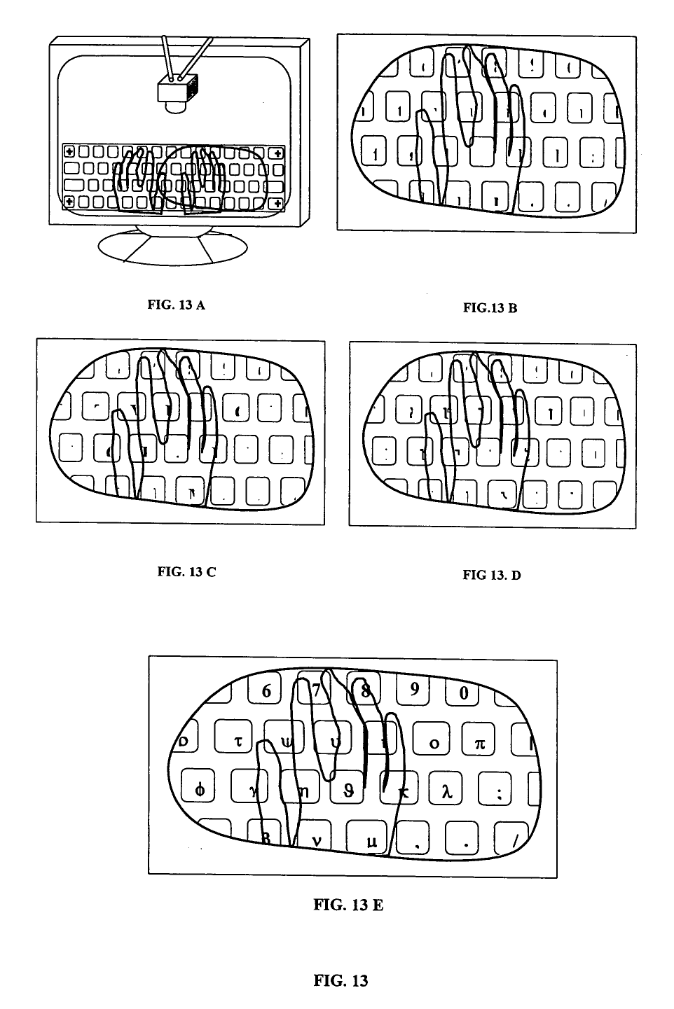

Finally, turning to FIG. 13, it is now straightforward to appreciate that the synthetic keyboard image seen on screen 13A can be modified by software operation to present various fonts—as in 13B-E. This seemingly ordinary transition makes the task of creative font compositions easy for the user. Furthermore, the physical keyboard need no longer include crowded clusters of complex and alternative fonts on each key—since the keyboard image on screen may accept any predetermined font assignment and portray it too.

The invention is not limited to the above description. For example, it is possible to perform the inventive method without a camera per se, and use instead heat sensors, magnetic or optical or similar position sensors under the keyboard, and the like. The registration marks may one or a combination of stickers attached to the keyboard, keyboard contours, etc. The identification of the model of the keyboard may be accomplished with DLL or some software or hardware connected to the keyboard or to a data library.

It should be noted that numbers, alphabetic characters, and roman symbols are designated in the above description for convenience of explanations only, and should by no means be regarded as imposing particular order on any method steps. Likewise, the present invention has been described with a certain degree of particularity, however those versed in the art will readily appreciate that various modifications and alterations may be carried out without departing from either the spirit or scope, which is defined in the claims appearing hereinbelow.

What is claimed is:

1. A method of facilitating human interaction with a computer having a keyboard and a display device, comprising the steps of:
a) identifying registration marks in a reference-image from an initialization video signal of a keyboard,
b) relating the reference image to a predetermined graphic keyboard representation using the identified registration marks;
c) processing data from post-initialization images of a keyboard in use by a user, the data including at least one of: i) at least one registration mark, and ii) differences between the reference-image and the post-initialization images;
d) overlaying at least a portion of the data processed in step c) onto the keyboard representation for at least a plurality of the post-initialization images; and
e) transmitting the overlaid portion to a graphics display device.

2. The method according to claim 1, wherein said identifying step includes the step of image processing.

3. The method according to claim 1, wherein said relating step includes the step of selecting a representation from a predetermined library.

4. The method according to claim 1, wherein said processing step includes at least one of the following operations:
c1) separating the non-reference image elements from reference-image elements by removing background elements;
c2) deforming isolated contiguous aggregates of non-reference image elements proportionally to a predetermined distortion of the reference image;
c3) deforming edges of isolated contiguous aggregates of non-reference image elements proportionally to a predetermined distortion of the reference image; and
c4) tracking changes in reference-image registration mark location.

5. The method according to claim 4, wherein processing of more than one of said operations c1)-c4) is performed substantially asynchronously.

6. The method according to claim 4, wherein said deforming operations c2) and c3) includes parameters necessary to transform a reference-image keyboard representation associated with the initialization registration marks into a substantially rectangular representation—thereby facilitating correction for angular parallax in the reference-image and in the images.

7. The method according to claim 1, wherein said overlaying step includes inclusion of registration mark normalized post-initialization video signal data edges onto the keyboard representation.

8. The method according to claim 1, wherein said overlaying step includes the step of including registration mark-normalized post-initialization video signal data semi-transparent contiguous portions onto the keyboard representation.

9. The method according to claim 1, wherein said overlaying step includes accepting a command signal and using the command to include a predetermined character set onto to keys of the keyboard representation.

10. The method according to claim 1, wherein said transmitting step includes transforming the representation and overlay into a region of the display device—thereby facilitating a user of a keyboard of a computer system associated with the display device to observe manual interactions with the keyboard on the display device.

11. The method according to claim 1, wherein said transmitting step includes the step of transforming the representation and overlay into a region of the display device into virtual buttons on the display device corresponding to the keys of the keyboard, thereby facilitating a user of the keyboard to use the keyboard as a mouse for activating the virtual buttons on the display device corresponding to keys of the imaged keyboard.

12. A method according to claim 1, wherein the differences between the reference image and the post-initialization images includes at least one of movement of the keyboard and placement of the user's hands on the keyboard.

13. A software-driven application keyboard imaging method comprising the steps of:
taking data from a video stream showing a keyboard associated with a computer and a display device; and
transposing a graphic equivalent of that data from the video stream onto a portion of the display device,
wherein an image of the keyboard is depicted on the display device.

14. The method according to claim 13, wherein said transposing step further comprising the steps of:
calibrating images from the video stream in order to identify the viewing angle between the real time images provided from the camera and the keyboard that it is pointed at and focused on;
using at least one of photogrammetric and homological algorithms to accomplish the keyboard validation;
transforming the validated keyboard into an abstract animated keyboard image; and
overlaying the abstract animated keyboard image onto a portion of the display device.

15. The method according to claim 13, wherein, after a user begins to type on the keyboard, the images include edge detected abstracted animated renditions of at least one portion of one of the user's hands, the hand portion being rendered as a substantially transparent outline and superimposed onto the image of the keyboard on the display device.

16. A method of facilitating human interaction with a computer having a data entry device and a display device, comprising the steps of:
projecting an image of the data entry device as the data entry device is being used onto a portion of the display device,
wherein the user can see both the image of the data entry device and the subject matter being created on the display device by the user's manipulation of the data entry device substantially simultaneously.

17. A method according to claim 16, further comprising the steps of:
providing registration marks on the data entry device to act as reference position indicators; and
adjusting the image of the data entry device according to the registration marks.

18. A method according to claim 16, further comprising the steps of:
providing at least one model indicator on the data entry device to identify the model of data entry device;
comparing the model indicator to a plurality of stored model indicators each indicative of a different data entry device; and
in said projecting step, projecting an image of the data entry device indicated by the model indicator onto the display device.

19. A method according to claim 17, further comprising the steps of:
providing at least one model indicator on the data entry device to identify the model of data entry device;
comparing the model indicator to a plurality of stored model indicators each indicative of a different data entry device; and
in said projecting step, projecting an image of the data entry device indicated by the model indicator onto the display device.

20. A method according to claim 16, further comprising the step of eliminating background elements surrounding the user's hands over the data entry device from the data entry device image.

21. A method according to claim 16, further comprising the step of altering the data entry device image in accordance with user instructions.

22. A method according to claim 21, wherein the data entry device is a keyboard and said altering step comprises the step of changing characters on at least a portion of the keys on the image of the keyboard, wherein typing on the actual keyboard will cause the generation of the changed characters on the display device.

23. A method according to claim 16, further comprising the step of superimposing an image of least a portion of at least one of the user's hands onto the data entry device image as the hands are positioned over the actual data entry device.

24. A method according to claim 23, wherein said superimposing step further comprises the step of making the superimposed image substantially transparent over the data entry device image.

25. A system for facilitating human interacting with a computer having a display device and a keyboard, comprising;
a moving image camera disposed over and pointed at the keyboard, said camera generating a video signal indicative of the keyboard;
means for displaying data from said video signal of the keyboard onto the display device as an image of the keyboard.

26. A system according to claim 25, further comprising:
registration marks provided in association with the keyboard; and
image repairing means for correcting distortion of said image of the keyboard in said video signal.

27. A system according to claim 26, wherein said image repairing means corrects for at least one of parallax and movement of the keyboard from an initial position.

28. A system according to claim 25, the computer including a CPU, wherein said means for displaying said video signal comprises software disposed on the CPU of the computer.

29. A system according to claim 25, further comprising a CPU separate from the computer, wherein said means for displaying said video signal comprises software disposed on said CPU.

30. A system according to claim 25, said means for displaying said video signal further comprises image altering means for changing the appearance of said image of the keyboard by altering said video signal.

31. A system according to claim 30, wherein said image altering means changes at least some of the characters on the keys of said image of the keyboard.

32. A system according to claim 30, wherein said image altering means eliminates background elements surrounding the user's hands above the keyboard in said image of the keyboard.

33. A system according to claim 30, wherein said image altering means makes a user's hands disposed over the keyboard transparent in said image of the keyboard.

34. A system according to claim 30, wherein said image altering means transforms keys of said image of the keyboard into hyperlinks.

35. A system according to claim 25, further comprising a camera holder attached to the display device, said camera being attached to said camera holder above the keyboard and pointing downward at the keyboard.

36. A system according to claim 25, further comprising:
a second camera disposed on the keyboard pointing upward at the user's hands, said second camera generating a second video signal indicative of at least a portion of at least one of the user's hands; and
means for displaying said second video signal onto the display device.

37. A system according to claim 36, wherein said means for displaying said second video signal transforms said second video signal into a transparent image of at least a portion of at least one of the user's hands and overlays said transparent image onto said image of the keyboard.

38. A system for facilitating use of a computer, comprising:
a computer including a display device and a keyboard;
a moving image camera disposed near and pointed at said keyboard, said camera generating a video signal indicative of said keyboard;
means for displaying said video signal of said keyboard onto said display device as an image of said keyboard.

39. A system according to claim 38, further comprising:
registration marks provided on a surface of said keyboard; and
image repairing means for correcting distortion of said image of said keyboard in said video signal.

40. A system according to claim 39, wherein said image repairing means corrects for at least one of parallax and movement of said keyboard from an initial position.

41. A system according to claim 38, said computer including a CPU, wherein said means for displaying said video signal comprises software disposed on said CPU of said computer.

42. A system according to claim 38, further comprising a CPU separate from said computer, wherein said means for displaying said video signal comprises software disposed on said CPU.

43. A system according to claim 38, said means for displaying said video signal further comprises image altering means for changing the appearance of said image of said keyboard by altering said video signal.

44. A system according to claim 43, wherein said image altering means changes at least some of the characters on the keys of said image of said keyboard.

45. A system according to claim 43, wherein said image altering means eliminates background elements surrounding the user's hands above said keyboard from said image of said keyboard.

46. A system according to claim 43, wherein said image altering means makes a user's hands disposed over said keyboard transparent in said image of said keyboard.

47. A system according to claim 43, wherein said image altering means transforms keys of said image of said keyboard into hyperlinks.

48. A system according to claim 38, further comprising a camera holder attached to said display device, said camera being attached to said camera holder above said keyboard and pointing downward at said keyboard.

49. A system according to claim 38, further comprising:
a second camera disposed on said keyboard pointing upward at the user's hands, said second camera generating a second video signal indicative of at least a portion of at least one of the user's hands; and
means for displaying said second video signal onto said display device.

50. A system according to claim 49, wherein said means for displaying said second video signal transforms said second video signal into a transparent image of at least a portion of at least one of the user's hands and overlays said transparent image onto said image of said keyboard.
